(19) United States
(12) Patent Application Publication
(10) Pub. No.: US 2011/0164044 A1
(43) Pub. Date: Jul. 7, 2011

(54) Preparation method for the virtual reality of high fidelity sports and fitness equipment and interactive system and method based on the virtual reality

(75) Inventor: Jung-Tang Huang, Taipei (TW)

(73) Assignee: Jung-Tang Huang

(21) Appl. No.: 12/930,380

(22) Filed: Jan. 6, 2011

(30) Foreign Application Priority Data
Dec. 30, 2009 (CN) 200910113654.4

(51) Int. Cl. G06T 13/00

(52) U.S. Cl. 345/473

(57) ABSTRACT

This invention is a preparation method for virtual reality of high fidelity sports and fitness equipment and an interactive system and method based on the virtual reality. Image content of real scene shooting and the control parameters of sports and fitness equipment correspond to real scene will be taken synchronously. The control parameters can let sports and fitness equipment, along with the change of real scene, adjust in real time and automatically its forward and backward leaning, left and right leaning, swinging angle, or adjust automatically its loading size; or follow the user's exercise speed to adjust the playing speed of the virtual reality; or follow the environmental parameters to adjust the loading size; or follow the staring direction of the eye of the user or the face direction of the user or the swinging angle of sports and fitness equipment to change visual field scope image of real scene; it can prepare diversified virtual reality digital content, it can reach high virtual level according to different exercise characteristic; the user won't be limited by the site and weather, and the application field becomes wider.

### 1. FIELD OF INVENTION

This invention relates to a preparation method for the virtual reality of high fidelity sports and fitness equipment and interactive system and method based on the virtual reality.

### 2. DESCRIPTION OF RELATED ART

The prior art interactive digital content of sports equipment mainly belongs to virtual reality. It has features such as: difficulty of preparation, the lack of diversity and difficulty to display the real situation of the true world, hence, the indoor use of the prior art sports equipment could easily let people have the feeling of the lack of freshness. Moreover, for sports and fitness equipment such as bicycle, treadmills and row machine, etc., there is corresponding leisure and entertainment sites, for example, leisure training site, or athlete rank game site. Currently, a company named Tunturi corporation of Finland in the market provides a real scene multimedia accompanied the fitness bicycle, the real scene multimedia can follow the bicycle riding speed from the user to adjust the real scene playing speed, it can also follow the road surface to adjust automatically the loading size of the bicycle; however, since the accompanied bicycle does not have a dynamic platform that can change the posture along with the road surface, there is thus no real riding feeling; in addition, this multimedia is only limited to bicycle, to treadmills, or row machine, skiing machine, surfing or water-skiing, or riding horse with single hand, no multimedia can be accompanied; furthermore, during the real exercise outdoors, the user might look around, and the real scene seen in the same site is usually decided by the direction the eye is staring at, in addition, the real world usually provides multi-path selection of hybrid tee road, but the above software provided by Tunturi corporation does not have such function, meanwhile, neither can it provide image corresponding to virtual reality to change the viewing field along with the user's change of location. Therefore, this invention is to improve the above drawbacks.

### SUMMARY

In order to improve the above mentioned issues, this invention has proposed a preparation method for the virtual reality of high fidelity sports and fitness equipment and interactive system and method based on the virtual reality. It can prepare digital content of virtual reality of innovative and diversified, it can also achieve higher fidelity level according to different exercise features, that is, the user will not be limited by exercise site or climate, and the application becomes wider. A preparation method for virtual reality of high fidelity sports and fitness equipment, which includes the following steps:

Step 1: Using a vehicle installed with camera equipment to go to exercise-implementation corresponding site for real scene shooting. Meanwhile, install multiple sensors according to exercise need so as to obtain control parameters for sports and fitness equipment that are corresponded to real scene, those control parameters can control sports and fitness equipment to make action change according to the real scene.

Step 2: Real scene will be taken for each fixed sampling time. Meanwhile, the measured data of each sensor will be taken simultaneously with the shooting action.

Step 3: Each image will be saved into array data structure, and the array data structure includes mileage data corresponding to sampling time, image content and the measured data of each sensor. Moreover, the image data will be divided, and front and back index or mark will be added so that mileage data and the real measured data of each sensor will be synchronous with the image data, and finally, the digital content of virtual reality will be formed.

The real scene can be two dimensional or three dimensional image, three dimensional image, or image of partial view or panoramic view.

The mentioned sensors should include at least one of the following sensors: mileage meter, inertia sensor, tilting sensor, water level sensor, GPS, air velocity meter, wind direction meter, water velocity meter, water direction meter, angle meter, microphone, gas sensor, illumination sensor, altitude sensor or humidity sensor.

The camera equipment is installed on rotational platform, when tee road picture is taken, the panoramic image of the tee road will be recorded using first the rotational platform, then the real scenes of different road sections extended from the tee road will be taken respectively. Several cameras can be used at the same time to make 360 degrees shooting, hence, there is no need to use rotational platform but the real scene at different angle can still be taken.

In the mentioned step 2, a fixed length image section can be used as a unit to divide the above digital content. Then the index of each unit is set up to represent the front and rear order and relationship of each image section, and the data structure of the image section includes identification code ID, image section length, image format, name, starting and ending coordinate, rear connection point ID and front connection point ID.

An interactive system based on virtual reality, comprising mainly of sports and fitness equipment, sports platform that can be rotated or translated in multi-axis, and controller connected to sports and fitness equipment or sports platform, several sensors installed at sports and fitness equipment or sports platform, display device and computer. Moreover, sports and fitness equipment is installed above sports platform, then display device is installed in the front side of sports and fitness equipment, and the display device is used to receive and play digital content of virtual reality coming from the computer; the computer, at a fixed sampling time, will take mileage data of sports platform or sports and fitness equipment and compare it with mileage data within the data structure of digital content of virtual reality, that is, the closest pointer or image frame serial number will be found out; meanwhile, through display device, the image content corresponding to the index or image frame serial number will be played; the correspondingly stored real measured data related to the sensors will be synchronously accessed, then it will be converted to the control order of sports platform or sports and fitness equipment and sent to the controller of sports platform or sports and fitness equipment, and sports and fitness equipment or sports platform will be adjusted automatically in terms of pitch, roll and yaw angle, or the translational displacement, speed or acceleration; or the size of the loading; meanwhile, computer will follow real measured data of all the sensors acquired synchronously with the mileage data so as to adjust the playing speed of the digital content of the virtual reality, or adjust the size of the loading of sports and fitness equipment according to the environmental variables provided by the sensors; or change, based on the stared direction of the user eye or the face direction or the swinging angle of sports and fitness equipment, the image of the visual field of the digital content of virtual reality.

The mentioned sports platform can include at least one of the following degree of freedom: that is, three rotational degrees of freedom: pitch, roll, yaw, and three translational shift degrees of freedom in X, Y, Z.

An interactive method based on virtual reality is to place sports and fitness equipment on sports platform that can be rotated or translated along multiple axes; moreover, the front side of sports and fitness equipment is installed with display device, and several sensors are installed on sports and fitness equipment or sports platform; then computer will, at each fixed sampling time, take the mileage data of sports platform or sports and fitness equipment and compare it with the mileage data within the data structure of digital content of virtual reality, then it will find out the closest pointer or image frame serial number; meanwhile, through display device, the image content corresponding to the index or image frame serial number will be played; the correspondingly stored real measured data related to the sensors will be synchronously accessed, then it will be converted to the control order of sports platform or sports and fitness equipment and sent to the controller of sports platform or sports and fitness equipment, and sports and fitness equipment or sports platform will be adjusted automatically in terms of pitch, roll and yaw angle, or the translational displacement, speed or acceleration; or the size of the loading; meanwhile, computer will follow real measured data of all the sensors acquired synchronously with the mileage data so as to adjust the playing speed of the digital content of the virtual reality, or adjust the size of the loading of sports and fitness equipment according to the environmental variables provided by the sensors; or change, based on the stared direction of the user eye or the face direction or the swinging angle of sports and fitness equipment, the image of the visual field of the digital content of virtual reality.

Computer will follow the real measured data from angle meter that is installed at the front end of sports and fitness equipment and is acquired synchronously with mileage data. When the user, within time T, samples mileage data of m, the rotational angle q of sports and fitness equipment is 0 degree, then the corresponding image content is found out according to mileage data m; when the user, within time T, has sampled mileage data of m, but the rotational angle is q degree, then the calculated mileage difference is k=m(sec q−1), after correction, mileage dataM=m(2−sec q), then the corrected mileage data M is followed to find out the corresponding image content.

The computer will also, based on the real measured data of angle meter installed at the front end of sports and fitness equipment, which is acquired synchronously with mileage data, control the left and right horizontal shift of image; moreover, based on the inertia sensor installed at the user's head, it will also control the up and down horizontal shift of the display image.

Moreover, computer, based on the real measured data of angle meter installed at the front end of sports and fitness equipment, which is acquired synchronously with mileage data, will judge whether the user, in virtual reality, drive along the left side or the right side of road; meanwhile, based on the deviated angle q of angle meter and mileage data m, the distance of left and right horizontal shift of visual field is obtained to be m tang, and the distance the user deviates away from the road center is then calculated; moreover, through the use of image processing technology, object getting closer will be amplified and object getting farther will be reduced.

Computer will also play the sound recorded during the process when mileage data is acquired synchronously and real scene is taken, or the music made in the post-production process, or the narrative.

The digital content of virtual reality prepared by adopting the idea of the present invention not only can interact with sports and fitness equipment to be used body building purpose, but also can be used as the body training of the athlete or the virtual practice site before the game, in the mean time, it can also be used for the promotion of the local scenery spot and tourism industry; in the interaction of virtual reality of the present invention and the user, the visual field can be changed along with the location change of the user, in the mean time, the exercise path of the user can be selected according to the real scene taken; moreover, the present invention also provides data streaming function so that real scene taken respectively or in different sections can be connected in seamless way according to the selection, that is, the loading and removing delay due to over-length film can be reduced, and the resource waste can be minimized.

### BRIEF DESCRIPTION OF DRAWINGS

The detailed drawings of this invention will be fully understood from the following descriptions wherein:

FIG. 1 shows the process of the preparation of virtual reality of sports and fitness equipment of the present invention.

FIG. 2 illustrates the road surface shooting equipment of the virtual reality preparation system of the sports and fitness equipment of the present invention.

FIG. 3 illustrates the road surface shooting operation of virtual reality of sports and fitness equipment of the present invention.

FIG. 4 illustrates the water surface shooting equipment of the virtual reality preparation system of sports and fitness equipment of the present invention.

FIG. 5 illustrates the water surface shooting operation of virtual reality of sports and fitness equipment of the present invention.

FIG. 6 illustrates the interaction between the digital content of virtual reality of the present invention and the bicycle installed at sports platform.

FIG. 7 illustrates the array data structure for storing virtual reality digital content of the present invention.

FIG. 8 illustrates the data structure of divisional image sections in the present invention.

FIG. 9 illustrates the correction of mileage data in the present invention.

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

### DETAILED DESCRIPTION

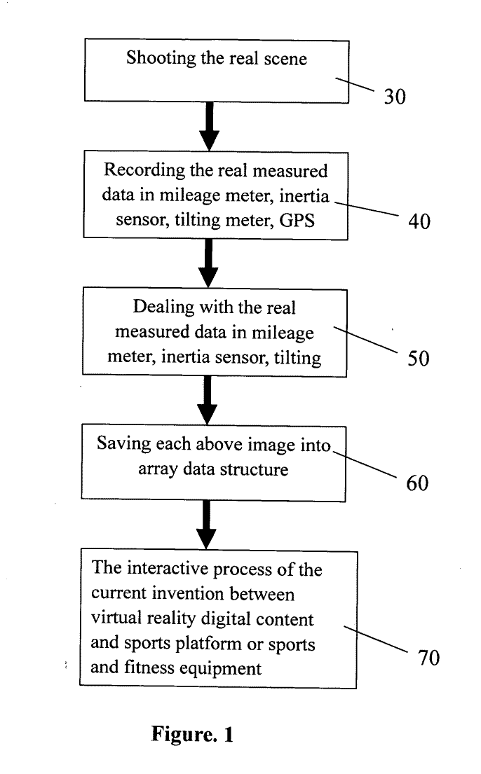

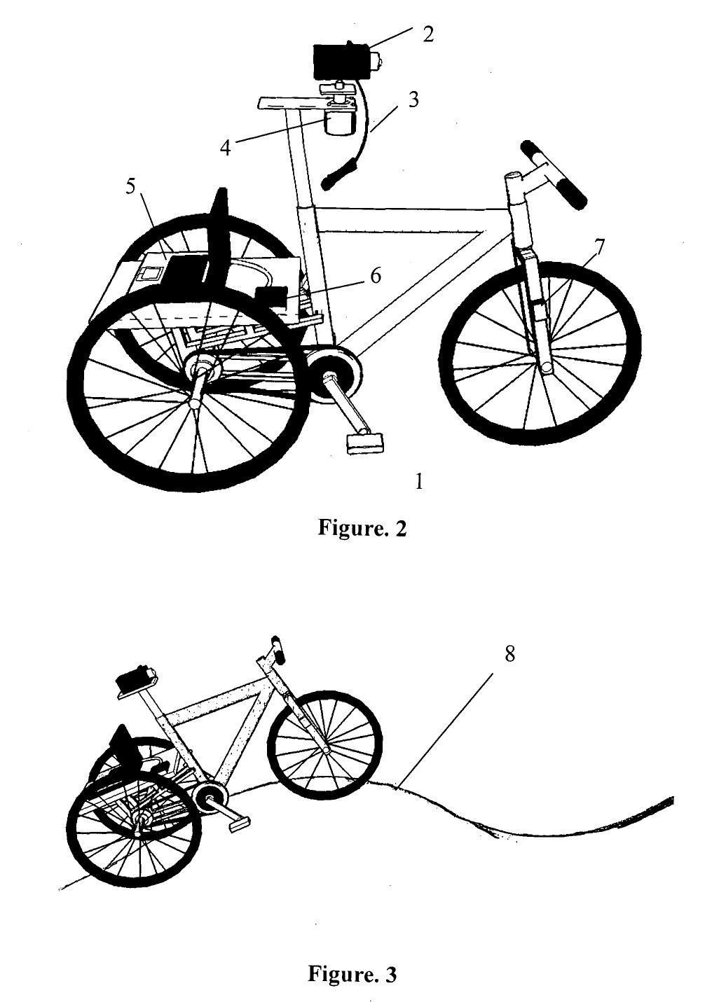

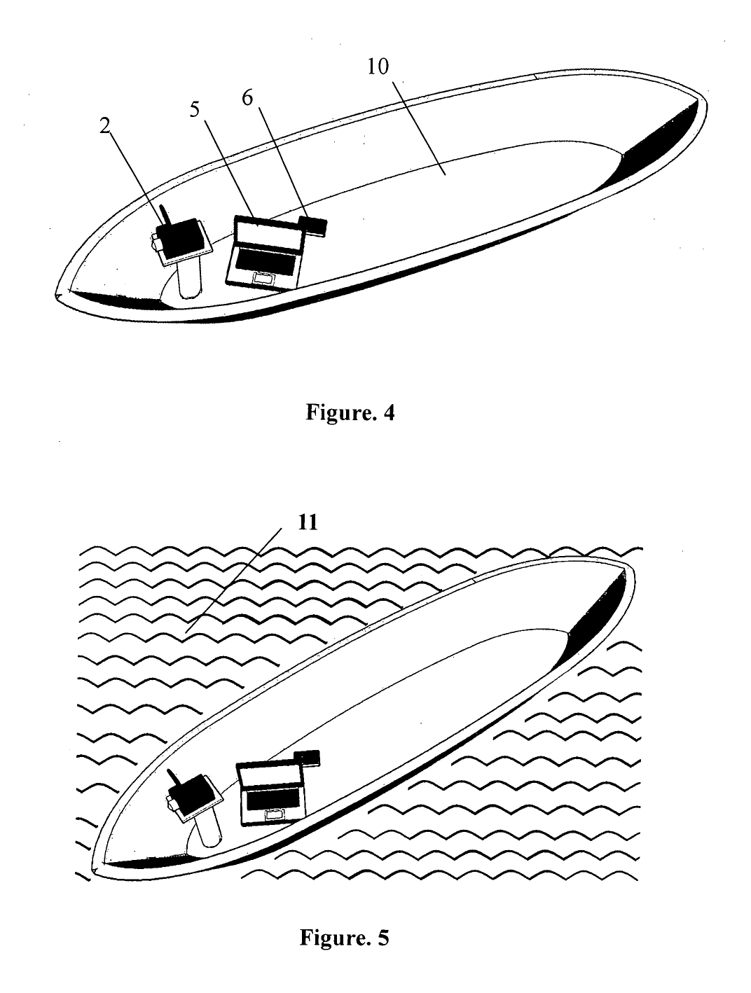

As shown in FIG. 1, this invention relates to a preparation method of high fidelity sports and fitness equipment virtual reality, which includes the following steps. For the preparation system of digital content of virtual reality, please refer simultaneously to FIG. 2 and FIG. 4:

Step 30: Using a vehicle installed with camera equipment and going to a site corresponding to the implementation of certain exercise to do real scene shooting; meanwhile, several sensors are installed according to exercise need so as to obtain the control parameters of sports and fitness equipment corresponding to the real scene, and the control parameter can control sports and fitness equipment to perform action change in accordance with real scene.

Step 40: Take real scene shooting on each fixed sampling time. The real scene can be two dimensional or three dimensional image, or three dimensional stereo image, and it can also be image of partial visual field or panoramic visual field; moreover, the real measured data in mileage meter, inertia sensor, tilting meter, GPS, air velocity meter and wind direction meter are take synchronously with the shooting action.

Step 50: Accompanied with the above real measured data of sensor, the image data is synchronized, interpolated or post-processed; the image data is divided, and added with front and rear index or mark.

Step 60: Save each above image into array data structure, and the array data structure includes real measured data of sensor corresponding to sampling time, for example, mileage data, image content, land or water surface three dimensional leaning level, acceleration and angular velocity, etc.

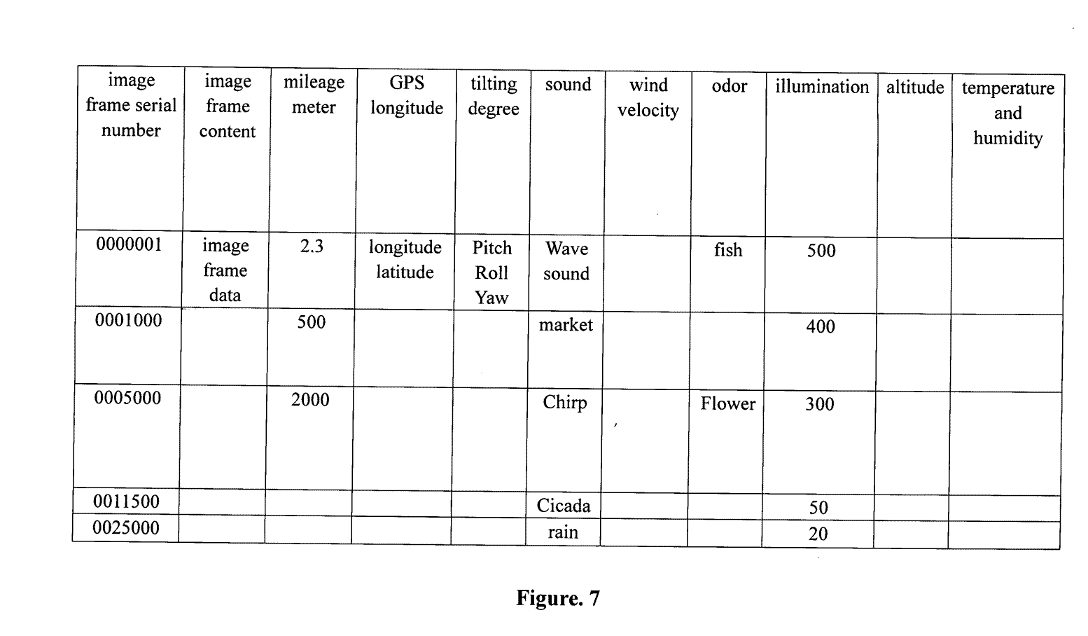

The storing format of the digital content of the virtual reality of the present invention is: At a fixed sampling time, the real measured data in mileage meter, tilting meter, accelerometer, gyroscope, GPS, air velocity meter, wind direction meter, etc. is recorded, and the image taken from the camera is recorded too. Better embodiment is based on the shooting rate of the camera, for example, the fixed sampling time is set up at 1/30 second, but for high speed camera, it can be 1/60 second or 1/120 second or 1/300 second, or other selections. The data structure of the digital content of virtual reality in step 60 is as shown in FIG. 7. The image frame serial number is the serial number of each image and section that is arranged according to shooting order or cutting order. Each image frame content corresponds respectively to parameters in the shooting, namely, mileage taken by mileage meter, longitude and latitude coordinate as taken by GPS, ground tilting as measured by tilting meter, real sound recorded by microphone or the music and sound made in the post-production, the wind velocity and direction measured by wind direction meter or in the post-production, odor and concentration recognized by gas sensor or in the post-production, illumination measured by illumination meter or in the post production, the altitude above sea level as measured by altitude meter and the temperature and humidity data taken by temperature and humidity sensor. The image frame content here can be the assembly image data taken by at least one camera, or the panoramic image data taken by panoramic camera, or the stereo image data taken by stereo camera.

The step 70 is the interactive process of the present invention between virtual reality digital content and sports platform or sports and fitness equipment: At fixed sampling time, the mileage location of sports platform or sports and fitness equipment is taken and compared to the mileage meter record within the data structure of digital content of virtual reality so as to find out the closest index or image frame serial number. Meanwhile, the image of corresponding index will be played, and the real measured data of corresponding index is provided, for example, accelerometer, tilting meter, gyroscope, GPS, air velocity meter, wind direction meter; other parameters will also be provided, for example, land or water surface three dimensional tilting level, acceleration and angle velocity. Hence, control orders such as multi-axis tilting angle, rotational speed, acceleration of horizontal motion of sports platform are generated and transferred to sports platform or sports and fitness equipment so as to adjust in real time and in interactive way parameters of sports and fitness equipment, namely, forward and backward leaning (pitch), left and right leaning (roll), yaw angle, or horizontal shift location, speed or acceleration; or the loading size of sports and fitness equipment can be adjusted automatically.

This invention is a virtual reality preparation method of high fidelity sports and fitness equipment. In this method, vehicle is used to go to the corresponding implementation site of certain exercise to perform shooting. In addition to using camera for the shooting, the real measured data of sensors are acquired synchronously and recorded, namely, mileage meter, three dimensional tilting meter, accelerometer, gyroscope, GPS, air velocity meter and wind direction meter. For the road surface application, for example, bicycle fitness machine, treadmills, horse riding machine, etc., the equipment needed for the preparation of virtual reality can be installed on stable transportation vehicle, and the equipment includes at least one camera (which can include rotational platform), tilting meter, acceleration meter, gyroscope, GPS, mileage meter, air velocity meter, wind direction meter, etc. For row machine or boating, large boat can be used; for surfing or water-skiing, small boat can be used; for the skiing machine, sledge can be used. Camera can be installed at appropriate location and angle based on the need.

During the shooting, the camera can be installed with vibration-proof platform, for example, Steadycam. Meanwhile, during the post-production, digital software is used, for example, SteadyMove, to further remove the vibration.

The camera can be high speed camera or general camera. It can also be panoramic shooting system or multiple cameras or single camera, it can be standard lens or wide-angle lens or telescope lens to accompany accelerometer, gyroscope, GPS and mileage meter.

Accompanied with post-production software, each image is saved as array data structure. The array data structure includes mileage location, image itself, land or water surface three dimensional tilting level, acceleration and angular velocity, etc.

The digital content of virtual reality of the present invention includes real scene and all kinds of control parameters. The real scene can be two dimensional or three dimensional image, can be partial visual field or panoramic visual field, and it can also include the music or narrative; control parameter includes the real measured data corresponds to each image content of virtual reality, namely, mileage, acceleration, angular velocity, etc.; therefore, sports and fitness equipment can, along with the change of real scene, adjust in real time and automatically the forward and backward leaning (pitch), left and right leaning (roll), yaw angle, or automatically adjust the loading size; or it can follow the exercise speed of the user to adjust the playing speed of the virtual reality, or it can use the individual accumulated speed of multiple exercisers as the basis of the winner of the competition. Furthermore, environmental variables can be included, for example, wind direction and wind velocity or water flow, to change the loading; or the stared direction of the user's eye or the face direction of the user can be used to change visual field scope and image in real scene projection. Wind direction and air velocity meter can be used to record, during the land motion, the downwind or upwind motion; water flow meter can be used to record, during water sports or boating, the down-water or up-water driving. For the stared direction of user's eye, the vision of the computer can be used to detect the direction of eyeball; for the face direction, it can be detected through the gyroscope worn at the head.

The real measured data of three axes acceleration meter can be used as the calculation basis. When time is done with first integration, we can obtain velocity, when time is done with second integration, we can obtain location. Therefore, through three axes acceleration meter, we can know the real three dimensional location corresponding to any image at the sampling time. For the accumulation error, the measured result of mileage meter and two axes gyroscope can be used for the calibration. In addition, the tilting level operation method attached to three axes acceleration meter can be used directly, or the three axes tilting meter can be used to get directly the tilting angle of three axes, that is, the tilting level of the ground in the proceeding route, or the tilting level of water surface in the proceeding route during the shooting process.

The control of sports platform is basically based on location order, but speed order can also be included to control the change of surfing board; acceleration order is a good method to generate extreme speed feeling for traditional virtual reality. Therefore, in this invention, location order, speed order and acceleration order are provided to sports platform to cope with different exercise characteristic and virtual reality level.

The sports platform can have multiple axes: three rotational axes and three horizontal shift axes. Although in the present invention, sports platform with three axes is used as example for explanation, however, since the real measured data of accelerometer and gyroscope can provide is complete information for three rotational axes and three translational axes, hence, the digital content of virtual reality of the present invention can be used by sports platform of more axes.

FIG. 2 illustrates the shooting equipment for road surface in the virtual reality preparation system of the present invention. Through the use of a stable vehicle 1, which can be automobile, motorcycle, bicycle or tricycle, or a walking person, etc., above it is a camera 2, camera stabilizing rack 3, rotational platform 4 (which is driven by step motor or servo motor accompanied with reducer), notebook PC 5, inertia sensor 6 and mileage meter 7. FIG. 3 is an embodiment of FIG. 2. We can also add air velocity meter, wind direction meter, etc. (Not shown in the figure).

During the shooting, since the road surface will make left and right leaning, which might lead to left and right vibration when the video is played, hence, camera stabilizer 3 is used to surmount left and right leaning and up and down tilting issues on the road surface, that is, the film taken will look smoother.

During the film shooting, it may meet tee road, hence, it will first use rotational platform 4 (It is driven by step motor or servo motor accompanied with reducer) to record the panoramic image at the tee road intersection point, then it will take respective film of different road sections extended from the tee road intersection point, hence, when the user is using the simulation exercise game, the user can select left turn, right turn or straight walk. In addition, multiple cameras can be used, for example, 8 cameras, to do panoramic shooting of 360 degrees, hence, there is no need to use rotational platform but the real scene at different angle can still be taken.

During film shooting, through the use of notebook computer 5 or any recordable device, we can record at the same time the image data taken by camera 2, mileage data taken by mileage meter 7, and the real measured data taken by all kinds of sensors such as inertia sensor 6, air velocity meter and wind direction meter. Moreover, control orders, converted from the data taken above, can also be obtained, can be obtained, for example, multiple axes tilting angle of sports platform or sports and fitness equipment, rotational speed, acceleration in the horizontal shift, etc.

For the influence from the climate during the shooting, post-production treatment can be used. The brightness or sunshine direction of the film taken individually can be adjusted using image processing technique so as to achieve consistency. During film shooting, it can use illumination meter for recording or adjust the brightness during the shooting.

FIG. 4 illustrates the water-surface shooting equipment of the preparation system of virtual reality of the present invention. We can use boat 10 for the installation of camera 2, and camera 2 can be one or more cameras, meanwhile, it can be placed on rotational platform too (Not shown in the figure). Moreover, there is also notebook computer 5 and inertia sensor 6, etc. When the film shooting is taken on creek, river, sea, lake or water surface 11, image data and real measured data of sensors such as mileage data or inertia sensor, etc. are recorded at the same time, which is as shown in FIG. 5. Furthermore, water velocity meter and water direction meter, etc. can also be added. When film shooting is done on creek and river, along and down the creek or river, the scenery at both sides can all be taken by the camera. For river or creek with water surface changes along with the land topography, the water surface height and tilting angle can be recorded at the same time along with moving location change. For the film shooting at wider water field, high pixel panoramic camera will be needed. For water field, multiple locations shooting is adopted, the shooting points will then form array to cover wide water field. Then the image post-production will mark the shooting of each location, and it is similar to the connection in array navigation shooting image. It is hoped that in the subsequent interaction with sports and fitness equipment for water related activity, the scope and resolution of the visual field image played can be adjusted along with location change, and the virtual feeling can then be achieved.

For aircraft in the air, basically, high resolution navigation image is used, and multiple point array type shooting method is used. Then image post treatment will mark the shooting at each location, and array type connection is used. It is hoped that in the subsequent interaction with sports and fitness equipment for air related activity, the scope and resolution of the visual field image played can be adjusted along with the change in flying altitude and location, and the virtual feeling can then be achieved. In addition, for the spatial visual field during the navigation, the shooting method in the above mentioned wide water field can be imitated; however, for the spatial field, three dimensional array type shooting is adopted, for the flying level and direction, panoramic shooting method is taken, for the ground scenes, navigation shooting way is taken, finally, image post treatment will be taken to mark, and final connection will be done during the playing process.

Each image of the digital content of this invention is saved into array data structure. The array data structure includes mileage location, image itself, three dimensional leaning level at the land and water surface, acceleration and angular velocity, etc. Hence, a fixed length of image section can be used as a unit for the division a series of recorded digital content. Index of each unit can be set up to represent the front and rear order and relationship of image section, then it can be played in streaming way or the data can be streamed. In another aspect, the selection of tee road can be fully embodied because the panoramic image at the tee road intersection is an unit, and the image of different road section extended from tee road intersection will be assigned as respective unit, hence, when the user is doing virtual exercise game, the user can select left turn, right turn or straight going. To sum up, we see that the present invention can provide serial connection function so that real scene taken respectively or in different sections can be made with all kinds of seamless connections when the user select straight walking, stay, left turn, right turn, or go-back. That is, the delay and resource waste caused by the loading and removing of over-length film can be reduced.

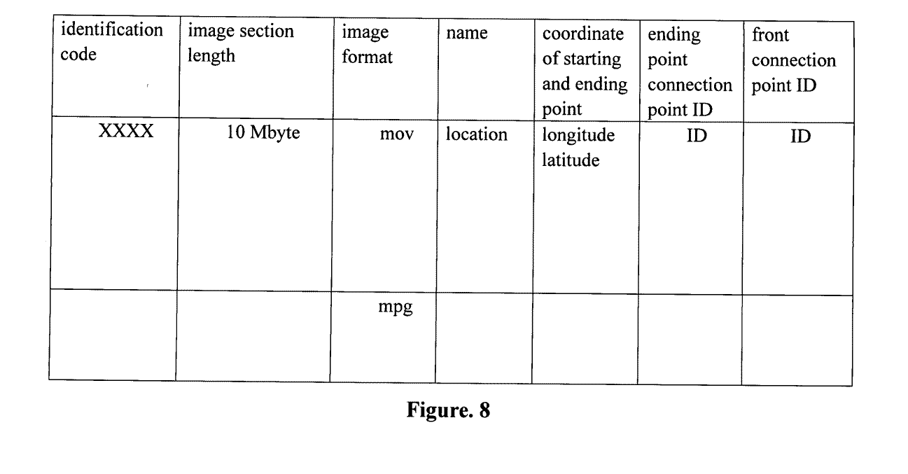

The above serial connection function means that the film taken can be cut and connected, unclear or temporarily paused image section can be removed, moreover, section-divided points can be set up according to the number of continuous image frame or the tee road; if the section-divided point is made according to continuous image frame number, then the image section length will be basically fixed, for example, 1-10 Mbyte; the data structure of image section is as shown in FIG. 8, which includes identification code (ID), image section length, image format, name, coordinate of starting and ending point, rear connection point ID and front connection point ID, etc.

The main objective to divide the digital content of virtual reality into sections is to let the user be able to get to big road and small alley to set up road network that is almost close to reality and is connected in dual directions to be used for multiple person competition or co-participation. Since there is usually multiple tee roads in real road network, the use of division technique can divide the real scene film into image section of fixed length, wherein panoramic film of multiple tee roads form an independent section. Then the above image section will be coded at the beginning and at the end, that is, the front connection point ID (image section ID to connect to the front end), back connection point ID (image section ID to connect to the back end). Each film section will be connected according to front and back code order. The branch road section of tee road connection will then be processed.

### Embodiment 1

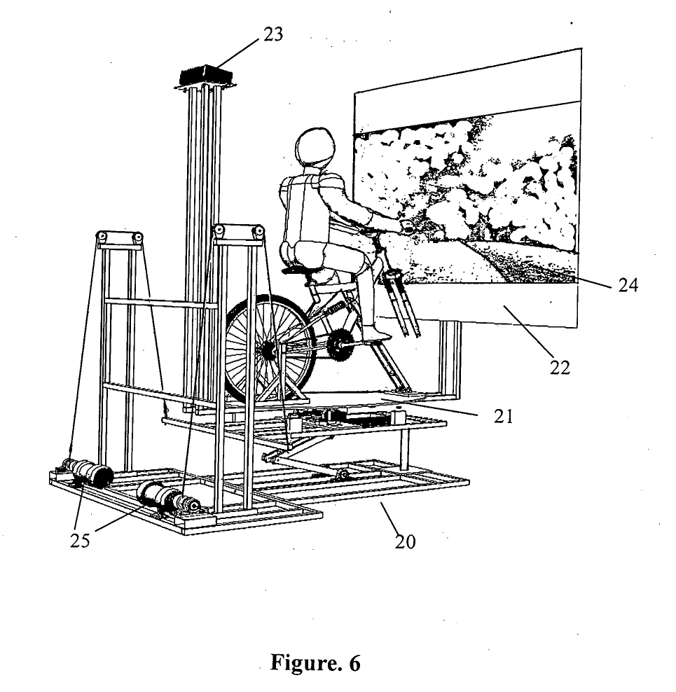

The interactive method between the digital content of virtual reality based on the present invention and multiple axes sports platform is as shown in FIG. 6. Put mountain bicycle 26 on the third rotational platform 21 of sports platform 20, install at the same time projection screen 22 in front of the bicycle, projector 23 is installed at the rear side of the bicycle and is connected to the computer (Not shown in the figure) to play virtual reality digital content 24 regarding cross-country exercise. The mentioned computer, at each fixed sampling time, will take the data of three axes angular position sensor, bicycle velocity sensor and mileage meter (Not shown in the figure) of sports platform 20. Moreover, the sampled mileage data will be compared to the mileage data of data structure of virtual reality digital content 24 to find out the closest index and to obtain data structure corresponding to that index, meanwhile, image content within the data structure will be played, and real measured data within the data structure involving sensor such as accelerometer, tilting meter, gyroscope, GPS, air velocity meter and wind direction meter, etc. will be uploaded to the computer. Moreover, based on the real measured data, it is converted to control orders of sports platform 20, namely, multiple axes tilting angle, rotational speed, horizontally moving acceleration, etc. to the controller of sports platform or sports and fitness equipment (Not shown in the figure) so as to drive multiple axes motor 25 and to change the exercise status of sports platform 20 to act in accordance with the real scene in the digital content, and finally, more real feeling can be obtained. Furthermore, controllable brake, for example, magnetic powder brake (Not shown in the figure) will be associated to the wheel to simulate the loading on the rider in the up-hill and down-hill road surface.

The mentioned sports platform 20 can include three degrees of freedom such as forward and backward leaning (pitch), left and right leaning (roll), yaw, and three translational movement degrees of freedom, namely, X, Y, Z.

During the real scene shooting, stable transportation vehicle (walking person will do) will be used for the installation of the equipment need for the preparation of virtual reality. The output of mileage meter is usually some square waves per second, or some counts, and the relatively converted mileage of each count will be different depending on the difference of transportation vehicle. For example, if the rider uses mountain bicycle 26, which is a 24 inches bicycle, then the tire will have a moving distance of 192 cm for each circle it makes; meanwhile, mileage meter will send out 10 counts, that is, each count will be corresponded to mileage of 19.2 cm. However, during the real scene shooting, the moving speed change might make the output per second of mileage meter be different than that of camera, hence, relative to the general image sampling speed of 30 image per second, it can use interpolation technique to correspond mileage data to each image data. Similarly, it can also use this interpolation technique to correspond mileage data to the measured value taken by three dimensional tilting meter, accelerometer, gyroscope, GPS, air velocity meter and wind direction meter, etc.

During the shooting process, there might be personal or other interference in the forwarding path, in order to get good image, multiple shooting can be used, then through the cut and paste technique in the post production, good prepared film can be selected to cover bad film in the same section, the film will then look more perfect. Moreover, it can also achieve this using image treatment such as averaging method, or the after-recognition cutting of human body or moving object. This can be achieved easily by anyone who is familiar with this art, and will not be mentioned more here.

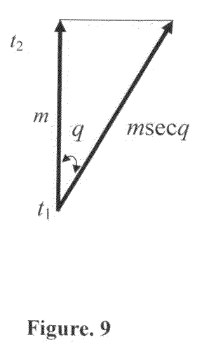

During the game exercise process, the user might get close to the right side, to the left side or run in snake way. Through the use of mileage data corresponding to each image data, the shooting direction of camera, and the deviation angle when the user moves, the mileage the user has ridden will then be calculated so as to change the playing speed of each image. Since the original shooting route corresponds to the visual field of the camera, if the user gets to the right side, to the left side, or runs in snake way, the playing visual field will also get to the left, to the right, or sometimes to the left and sometimes to the right, which might lead to the obvious deviation between the user's moving route and the original shooting route, and the sampled mileage data will then be higher than the original shooting route distance; if the sampled mileage data is used to search corresponding playing content, error will necessarily occur. In this invention, the calculation method of FIG. 9 is used to correct sampled mileage data so that corrected mileage data can search and play corresponding image content. The calculation method can also let the user know the mileage the user has made, instead of the virtual mileage in the traditional game.

As shown in FIG. 9, m is, within time T=t₂−t₁, the distance the user has ridden; q is the rotational angle the handle has made, then through the use of triangular function, we can obtain the distance of the slope msecq, we then know the mileage distance is k=m(sec q−1). When the user, within time T, has sampled mileage data of m, and the rotational angle of the handle q is 0 degree, then mileage data m is used to search the corresponding image content; when the user, within time T, has sampled mileage data of m, but the rotational angle of handle is q degree, then the mileage distance needs to be calculated k=m(sec q−1), after the correction, mileage dataM=m(2−sec q), then the corrected mileage data M is followed to search the corresponding image content.

Through the use of the real measured data of angle meter installed at the head of bicycle 26, it can control the left and right horizontal movement of the display image, then the rider only needs to rotate the head of bicycle 26 to control the left and right horizontal movement of the display image.

Since the shooting can only be taken in the middle of the road but can not be taken in multi-road forwarding way, then through the following method, it can turn two dimensional real image into virtual reality similar to three dimensional. Due to the focal length of human eye, when the object gets farther, the object seen by human eye will get smaller, on the contrary, when the object gets nearer, the object seen by human eye will get larger. Therefore, in this invention, geometrical image conversion is used, when the user gets to the left side or right side of the road, the object gets closer will be amplified, but the object gets farther will be reduced, which is to analogize the effect of virtual reality. An embodiment is: Through the angle q of the angle meter of head of bicycle 26 and the mileage data m of bicycle 26, then the left and right horizontal movement of visual field is m tang, then the deviation of the user from the road center is estimated, and image processing technique is used to make the closer object amplified and the farther object reduced; if water level sensor is added to human head, for example, multi-axis gyroscope, it can then see whether the user has the head raised up or down, and the up and down shift of the film can then be controlled; therefore, this invention can let the user have the feeling of riding bicycle outdoors, and virtual reality analogized to real image is then created.

Furthermore, if treadmill is placed on sports platform 20, then the virtual reality digital content of the present invention can provide the digital content needed according to the mileage and speed of treadmill. Moreover, if the jogging person wear inertia sensor or if the treadmill is installed with the location sensor of bicycle, then it can detect the distance the jogging person deviates away from road center; meanwhile, it can also be the same as the above bicycle embodiment, that is, through the use of image processing technique, the closer object will get amplified, and the farther object will get reduced.

### Embodiment 2

Through interne connection and through the use of the data streaming technique of virtual reality digital content of the present invention, mobile type real scene virtualization, use or browsing is performed, and local related advertisement promotion is then carried out. For example, when the rider passes through a supermarket, a store can provide direction guide to guide the rider to go browsing at the store that provides the advertisement. If it is resort area such as Kenting National Park, the store or hotel of the resort area can be asked to provide advertisement to introduce their best sale information, especially special food, or souvenir or room, etc.

Through internet connection, co-riding experience of multiple persons or co-visiting experience of multiple persons can be provided; or all kinds of competitions might be added, for example, France-surrounded game, Taiwan-surrounded game, Township-surrounded game, County-surrounded game, North-surrounded game, Middle-surrounded game, South-surrounded game and East-surrounded game, etc. Through the use of the technology of the present invention, virtual game could easily take place, not limited by typhoon or rainy day, not limited by day or night time; it is safe, no need of traffic control, no accident, no collision among the racers, most importantly, it is safe and no cheating at all.

Through internet connection, more people can be attracted to participate in the bicycle tourism way. Moreover, there are routes available, namely, parent-child co-riding route, romantic co-riding route, and bicycle riding reunion activity route can even provide a platform for male and female to get to know each other when they are at marriage age. In each scenery route, the land topography can be controlled, basically, it is like karaoke, that is, the key can be adjusted according to the sound field of any individual, hence, both male and female can ride together.

To sum up, this invention can produce the virtual reality digital content of all kinds of mobile exercise equipments, and these exercise equipments can include treadmill, bicycle, row machine, skiing machine, horse riding machine, surfing board, etc.; car racing, motorcycle, sledge, aircraft, water-skiing board and aircraft over water, etc.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes may be made in details, particularly in matters of shape, size and arrangement of parts without exceeding the scope of the invention.

What is claimed is:

1. A preparation method for virtual reality of high fidelity sports and fitness equipment with features comprising of the following steps:
Step 1: Use a vehicle installed with camera equipment to go to a site corresponding to the implementation of certain exercise to perform real scene shooting, meanwhile, based on the exercise need, several sensors are set up to obtain control parameters of sports and fitness equipment that corresponds to real scene, moreover, the control parameter can control sports and fitness equipment to perform action change in accordance with real scene;
Step 2: At each fixed sampling time, real scene is taken, then the real measured data of each sensor is taken synchronously with the shooting action;
Step 3: Save each image into array data structure, which includes mileage data, image content and the real measured data of each sensor of corresponding sampling time; meanwhile, the image data is divided, and front and rear index or mark is added so that the mileage data, real measured data of each sensor and the image data is synchronized to form the digital content of virtual reality.

2. The preparation method of claim 1, wherein said real scene is divided into two dimensional or three dimensional image, three dimensional stereo image, partial visual field or panoramic visual field image.

3. The preparation method of claim 1, wherein said sensor at least includes one of the following sensors: mileage meter, inertia sensor, tilting meter, water level sensor, GPS, air velocity meter, wind direction meter, water velocity meter, water direction meter, angle meter, microphone, gas sensor, illumination meter, altitude meter or humidity meter.

4. The preparation method of claim 1, wherein said camera equipment is installed at rotational platform to take the panoramic image at the tee road intersection firstly, then the real scenes of different road sections extended from the tee road intersection are taken respectively.

5. The preparation method of claim 1, wherein said camera equipment comprising of multiple cameras used for 360 degrees shooting instead using rotational platform, and the real scene at different angles is taken in the entire process.

6. The preparation method of claim 1, wherein said step 2, image section of a fixed length is used as a unit to divide the above digital content; each unit is set up with index to represent the front and rear order and relationship of image section; and the data structure of the image section includes identification code ID, image section length, image format, name, starting and ending point coordinate, rear connection point ID and front connection point ID.

7. An interactive system based on virtual reality mainly comprising of: sports and fitness equipment, sports platform rotated or translated in multiple axes, controller connected to sports and fitness equipment or sports platform, multiple sensors installed at sports and fitness equipment or sports platform, display equipment and computer; sports and fitness equipment are placed above sports platform, display equipment is installed in front of the sports and fitness equipment, and the display equipment is used to receive and play digital content coming from computer and regarding virtual reality; the computer, at a fixed sampling time, acquires mileage data from sports platform or sports and fitness equipment and compare it with mileage data within data structure of digital content of virtual reality so as to find out the closest index or image frame serial number, meanwhile, through display device, the image content corresponding to the index or image frame serial number is played; the correspondingly stored real measured data related to the sensors is synchronously accessed, then it is converted to the control order of sports platform or sports and fitness equipment and sent to the controller of sports platform or sports and fitness equipment, and sports and fitness equipment or sports platform is adjusted automatically and in terms of pitch, roll, yaw angle, or the translation displacements, speed or acceleration, or the size of the loading; meanwhile, computer follows real measured data of all the sensors acquired synchronously with the mileage data so as to adjust the playing speed of the digital content of the virtual reality, or adjust the size of the loading of sports and fitness equipment according to the environmental variables provided by the sensors; or change, based on the stared direction of the user eye or the face direction or the swinging angle of sports and fitness equipment, the image of the visual field of the digital content of virtual reality.

8. The interactive system of claim 7, wherein said sports platform includes at least one of the following degrees of freedom: three rotational degrees of freedom such as pitch, roll and yaw, and three translational degrees of freedom of X, Y and Z.

9. The interactive system of claim 7, wherein an angle meter is installed further at the front end of sports and fitness equipment such that the computer is, based on the real measured data of angle meter installed, to control the left and right horizontal shift of image synchronously with mileage data; moreover, based on the inertia sensor installed at the user's head, the up and down horizontal shift of the display image is also controlled.

10. The interactive system of claim 9, wherein said computer, based on the real measured data of angle meter installed at the front end of sports and fitness equipment, which is acquired synchronously with mileage data, judges whether the user, in virtual reality, drive along the left side or the right side of road; meanwhile, based on the deviated angle q of angle meter and mileage data m, the distance of left and right horizontal shift of visual field is obtained to be m tang, and the distance the user deviates away from the road center is then calculated; moreover, through the use of image processing technology, object getting closer is amplified and object getting farther is reduced.

11. The interactive system of claim 7, wherein said computer also plays the sound recorded during the process when mileage data is acquired synchronously and real scene is taken, or the music made in the post-production process, or the narrative.
